(19) United States
(12) Patent Application Publication
(10) Pub. No.: US 2020/0362070 A1
(43) Pub. Date: Nov. 19, 2020

(54) A Process for the Preparation of a Polymer Composition

(71) Applicant: BASF SE, Ludwingshafen and Rhein (DE)

(72) Inventors: Stephan Salzinger, SN Heerenveen (NL); Andreas Brodhagen, Ludwingshafen (DE); Yannick Fuchs, Ludwingshafen (DE); Domink Lanzinger, Ludwingshafen (DE); Helmut Eitteler, Ludwingshafen (DE)

(21) Appl. No.: 16/961,855

(22) PCT Filed: Jan. 15, 2019
(86) PCT No.: PCT/EP2019/050973

§ 371 Date: Jul. 13, 2020

(30) Foreign Application Priority Data
Jan. 31, 2018 (EP) 18154422.2

(51) Int. Cl. C08F 120/06

(52) U.S. Cl. CPC C08F 120/06

(57) ABSTRACT

The present disclosure relates to a process for the preparation of a polymer composition including at least one polymer and at least one polyether compound (PE). The polymer is obtained by radical polymerization of a monomer composition (M) including at least one olefinically unsaturated acid monomer and optionally further monomers such as a chain transfer agent. The radical polymerization is carried out in at least one reactor operated in batch or semibatch mode and in the presence of the polyether compound (PE). The reactor comprises a volume-based heat removal power (A) of at least 3 kW/(m³·K) and has a volume of at least 10 L.

The present invention relates to a process for the preparation of a polymer composition comprising at least one polymer and at least one polyether compound (PE). The polymer is obtained by radical polymerization of a monomer composition (M) comprising at least one olefinically unsaturated acid monomer and optionally further monomers such as a chain transfer agent. The radical polymerization is carried out in at least one reactor operated in batch or semibatch mode and in the presence of the lyether compound (PE). The reactor comprises a volume-based heat removal power (A) of at least 3 kW/(m³·K) and has a volume of at least 10 I.

Functional polymers and non-ionic surfactants, like polyethers, are used in products for many different applications, such as home care, personal care, crop protection, or oil and gas production. However, the combination of a functional polymer and a polyether, can be synthetically challenging and often leads to unstable mixtures and phase separation. In particular, polyethers with a melting temperature in the range of 15 to 50° C. are highly viscous and sticky waxes, resulting in expensive handling and difficulties to introduce them into solid formulations. Furthermore, they are poorly miscible in aqueous solution with functional polymers having acid functions, such as polyacrylic acid, which are usually also part of the respective formulations.

The preparation of compositions comprising polymers such as polyacids and polyethers is known in the literature:

WO 2015/000971 A1 describes a method for producing gel-like polymer compositions from an α,β-ethylenically unsaturated acid monomer and further crosslinking monomers via radical polymerization in the presence of a polyether. The method described in WO 2015/000971 A1 is a semi-batch process, in which the polyether is metered into a stirred-tank reactor and the monomers and a radical starter are fed to the reactor either continuously, periodically or with a constant or alternating dosage. A crosslinker/chain transfer agent can either be metered into the stirred-tank reactor together with the polyether or can be fed to the reactor separately from the monomers. However, WO 2015/000971 A1 is entirely silent about the volume-based heat removal power of the respective reactors employed therein.

A similar method is described in WO 2015/000970 A1, in which an α,β-ethylenically unsaturated acid monomer and further cross-linking monomers are subjected to a radical polymerization reaction in the presence of a polyether compound. The preparation of the solid polymer compositions is carried out using a stirred-tank reactor in semi-batch operation.

The use of stirred-tank reactors for the preparation of the aforementioned polymer compositions was shown to be feasible, however, the high product viscosity causes heat and mass transfer limitations, which hinder scale-up to production. The high viscosity of the polyethers leads to difficulties when blending the polyacid and the polyether and necessitates longer mixing times. Moreover, long cycle times are necessary in order to remove the heat of polymerization and a high-temperature operation may lead to esterification. Additionally, the high product viscosity makes the process very prone to fouling on the cooling surface.

The international application PCT/EP2017/069406 discloses a process for the preparation of a polymer composition comprising at least one polymer and at least one polyether compound, wherein the polymer is obtained by radical polymerization of a monomer composition. The radical polymerization is carried out in at least one continuously operated back-mixed reactor. However, it is not disclosed within said application that the respective process can be carried out within a reactor operated in batch or semibatch mode and/or the respective reactor comprises a specific volume-based heat removal power.

Further continuous processes for carrying out a radical polymerization are known, for example, from WO 2014/090743 or WO 2009/133186. However, the respective disclosure is focused on a continuous operation mode of the respective reactor and scale-up problems for a batch or semibatch mode operation are not considered therein.

It was therefore an object of the present invention to provide a new process for the preparation of polymer compositions comprising polymers and polyethers. This process should enable a good heat transfer performance even at larger production scales and should require shorter cycle times in order to remove the heat of polymerization.

This object is achieved by a process for the preparation of a polymer composition comprising at least one polymer and at least one polyether compound (PE), wherein the polymer is obtained by radical polymerization of a monomer composition (M) which comprises the following monomer components a) and b):
a) at least one olefinically unsaturated acid monomer (monomer component a)),
b) optionally at least one chain transfer agent (monomer component b)),
and wherein the radical polymerization is carried out in the presence of at least one polyether compound (PE) within at least one reactor, wherein
i) the at least one reactor is operated in batch or semibatch mode,
ii) the at least one reactor comprises a volume-based heat removal power (A) of at least 3 kW/(m³·K), and
iii) the at least one reactor has a volume of at least 10 I.

It has surprisingly been found that reactors operated in batch or semibatch mode and having a volume-based heat removal power of at least 3 kW/(m³·K), and in particular loop reactors comprising millistructured reaction zones, are suitable for the preparation of such polymer compositions. The inventive process enables a good heat transfer performance, resulting in shorter cycle times in order to remove the heat of polymerization more efficiently and/or faster.

These advantages also lead to increased space-time yields and thus, lower production costs, and ensure simple and low-risk scale-up even for polymer compositions of high viscosity. Furthermore, polymerization reactions with higher solid content can be performed without any problems, yielding products of higher viscosity that are not feasible with conventional batch or semibatch reactors.

In the context of the present invention, the definitions such as C₁-C₃₀-alkyl, as defined, for example, below for the R² radical in formula (I), mean that this substituent (radical) is an alkyl radical having a carbon atom number from 1 to 30. The alkyl radical may be either linear or branched and optionally cyclic. Alkyl radicals which have both a cyclic and a linear component are likewise covered by this definition. The same also applies to other alkyl radicals, for example a C₁-C₄-alkyl radical or a C₁₆-C₂₂-alkyl radical. The alkyl radicals may optionally also be mono- or polysubstituted by functional groups such as amino, quaternary ammonium, hydroxyl, halogen, aryl or heteroaryl. Unless stated otherwise, the alkyl radicals preferably do not have any functional groups as substituents. Examples of alkyl radicals are methyl, ethyl, n-propyl, isopropyl, n-butyl, isobutyl, 2-ethylhexyl, tert-butyl (tert-Bu/t-Bu), cyclohexyl, octyl, stearyl or behenyl.

In the context of the present invention, some compounds which can be derived from acrylic acid and methacrylic acid are abbreviated by insertion of the “(meth)” syllable into the compound name of the compound derived from acrylic acid. For example, the term “(meth)acrylic acid” refers both to acrylic acid and methacrylic acid.

The present invention is specified further hereinafter.

The polymer compositions obtained in the inventive process comprise at least one polymer and at least one polyether compound (PE) and are prepared by radical polymerization of the monomer composition (M) in the presence of the at least one polyether compound (PE).

The polymer compositions obtained according to the inventive process quite generally comprise the process products of radical polymerization, which are understood to mean, for example, homo- and copolymers of the monomers present in the monomer mixture (M).

The components present in the monomer composition (M), the at least one polyether compound (PE) and any further optional components that are described below, as well as the amounts of these components all refer to the respective components and amounts before carrying out the radical polymerization.

The monomer composition (M) comprises at least one olefinically unsaturated acid monomers as monomer component a).

Suitable olefinically unsaturated acid monomers as monomer component a) are known to the person skilled in the art. In principle, it is possible to use any of the olefinically unsaturated acid monomers that are known to the person skilled in the art and/or that can be produced by known methods.

In the context of the present invention, “olefinically unsaturated acid monomers” are compounds having at least one acid functional group such as a carboxylic acid group, a sulfonic acid group or a phosphonic acid group and which additionally comprise at least one hydrocarbon moiety having at least one carbon-carbon double bond.

Preferably, the at least one olefinically unsaturated acid monomer a) is selected from α,β-ethylenically unsaturated carboxylic acid monomers, α,β-ethylenically unsaturated sulfonic acid monomers or α,β-ethylenically unsaturated phosphonic acid monomers.

More preferably, the at least one olefinically unsaturated acid monomer a) consists of at least one α,β-ethylenically unsaturated carboxylic acid monomer.

The term “α,β-ethylenically unsaturated” refers to a specific distance of a carbon-carbon double bond of a hydrocarbon moiety relative to the carbon atom of an acid functional group. In an α,β-ethylenically unsaturated acid monomer, the carbon atom adjacent to the acid functional group and the next carbon atom of the hydrocarbon moiety are connected by a carbon-carbon double bond. Examples of α,β-ethylenically unsaturated acid monomers are described below.

Preferably, the at least one olefinically unsaturated acid monomer a) is selected from acrylic acid, methacrylic acid, ethacrylic acid, α-chloroacrylic acid, crotonic acid, maleic acid, itaconic acid, citraconic acid, mesaconic acid, glutaconic acid, aconitic acid, fumaric acid, 2-acrylamido-2-methylpropanesulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, vinylphosphonic acid or allylphosphonic acid. More preferably, the at least one olefinically unsaturated acid monomer a) is selected from acrylic acid or methacrylic acid and most preferably the at least one olefinically unsaturated acid monomer a) is acrylic acid.

The term “at least one olefinically unsaturated acid monomer” also includes the salts of the aforementioned acids, especially the sodium, potassium and ammonium salts, and also the salts with amines. The at least one olefinically unsaturated acid monomer a) can be any one of the aforementioned compounds or a mixture of two or more of the aforementioned compounds.

Preferably, the monomer component a) is used in acid form (non-neutralized form) for polymerization. The proportions by weight stated all refer to the acid form.

Preferably, the monomer composition (M) comprises at least 40% by weight, preferably at least 60% by weight, especially at least 90% by weight, based on the total weight of the monomer composition (M), of monomer component a). The proportions by weight of all monomer components present in the monomer composition (M) all refer to the acid form and generally add up to 100%.

In a preferred embodiment, the monomer composition (M) comprises at least 40% by weight, preferably at least 60% by weight, especially at least 90% by weight, based on the total weight of the monomer composition (M), of acrylic acid or methacrylic acid.

In another preferred embodiment, the monomer composition (M) comprises at least 40% by weight, preferably at least 60% by weight, especially at least 90% by weight, based on the total weight of the monomer composition (M), of a mixture of acrylic acid and methacrylic acid.

In this preferred embodiment, the monomer component a) in the monomer composition (M) preferably comprises acrylic acid in an amount ranging from 10 to 90% by weight, more preferably from 20 to 80% by weight and especially from 30 to 70% by weight and preferably comprises methacrylic acid in an amount ranging from 90 to 10% by weight, more preferably from 80 to 20% by weight and especially from 70 to 30% by weight, all based on the total weight of the monomer component a) in the monomer composition (M). Particularly preferably, the monomer component a) comprises 50% by weight of acrylic acid and 50% by weight of methacrylic acid, based on the total weight of the monomer component a) in the monomer composition (M).

In one preferred embodiment, the monomer composition (M) comprises at least 40% by weight, preferably at least 60% by weight, especially least 90% by weight, based on the total weight of the monomer composition (M), of acrylic acid.

When the monomer component a) comprises at least one olefinically unsaturated acid monomer component selected from a,8-ethylenically unsaturated sulfonic acid monomers or a,8-ethylenically unsaturated phosphonic acid monomers , the monomer composition (M) preferably comprises an amount of 0.1 to 40% by weight, more preferably 1% to 25% by weight, based on the total weight of the monomer composition (M), of said olefinically unsaturated acid monomer.

The radical polymerization can optionally be carried out in the presence of at least one chain transfer agent as monomer component b).

Chain transfer agents refer generally to compounds with high transfer constants. Chain transfer agents accelerate chain transfer reactions and hence bring about a lowering of the degree of polymerization of the resulting polymers, without influencing the gross reaction rate. For chain transfer agents, a distinction can be drawn between mono-, bi- or polyfunctional chain transfer agents according to the number of functional groups in the molecule, which can lead to one or more chain transfer reactions.

Suitable chain transfer agents are known to the person skilled in the art and are described in detail, for example, by K. C. Berger and G. Brandrup in J. Brandrup, E. H. Immergut, Polymer Handbook, 3rd ed., John Wiley & Sons, New York, 1989, p. 11/81-11/141.

Suitable chain transfer agents b) are, for example, aldehydes such as formaldehyde, acetaldehyde, propionaldehyde, n-butyraldehyde or isobutyraldehyde.

In addition, the chain transfer agents b) used may also be formic acid, the salts or esters thereof such as ammonium formate, 2,5-diphenyl-1-hexene, hydroxylammonium sulfate or hydroxylammonium phosphate.

Compounds which are suitable as chain transfer agents b) and can also serve as solvents are mono- and polyfunctional alcohols. For example, they may be selected individually or in a combination from ethyl alcohol, methyl alcohol, propyl alcohol, isopropanol, butyl alcohol, isobutanol, tert-butyl alcohol, pentyl alcohol, higher alcohols of C12 to C14, methoxyethanol, ethoxyethanol, propoxyethanol, ethylene glycol monoacetate, cyclohexanol, benzyl alcohol, phenethyl alcohol and the like, and from alkylene glycols, for example ethylene glycol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, neopentyl glycol, 1,5-pentanediol, 2,3-pentanediol, 2,4-pentanediol, 1,6-hexanediol and the like; hydroquinone diethylol ether; ethylene glycol derivatives, for example diethylene glycol, triethylene glycol and the like; aliphatic polyfunctional alcohols, for example sorbitol, cyclohexanediol, xylylenediol and the like; glycerol and mono- or disubstituted derivatives thereof comprising fatty acid glyceryl esters, for example monoacetin, monolaurin, monoolein, monopalmitin, monostearin and the like, and glyceryl monoethers, for example thymyl alcohol, glyceryl monomethyl ether, butyl alcohol and the like; trimethylolpropane and mono- or disubstituted derivatives thereof; pentaerythritol and mono- to trisubstituted derivatives thereof, for example pentaerythrityl dioleate and pentaerythrityl distearate; a fatty acid-sorbitan ester; hydroxycarboxylic acids such as citric acid, lactic acid, tartaric acid, gluconic acid and glucoheptonic acid; monosaccharides, for example erythritol, threose, ribose, arabinose, xylose, lyxose, allose, aldose, glucose, mannose, gulose, idose, galactose, talose, fructose, apiose, rhamnose, psicose, sorbose, tagarose, ribulose, xylulose and the like; disaccharides, for example sucrose, realrose, lactose and the like.

These alcohols have no addition polymerization reactivity and can be selected according to the use of the polymer composition to be obtained. In addition, the homogeneity of the reaction system is increased when the viscosity is low in the course of the polymerization reaction. The alcohol preferably has a low molecular weight. For example, the molecular weight is 400 g/mol or less and more preferably 200 g/mol or less.

Further suitable chain transfer agents b) are allyl compounds, for example allyl alcohol, functionalized allyl ethers such as allyl ethoxylates, alkyl allyl ethers or glyceryl monoallyl ether.

Compounds of this type are, for example, inorganic hydrogensulfites, disulfites and dithionites, or organic sulfides, disulfides, polysulfides, sulfoxides and sulfones. These include di-n-butyl sulfide, di-n-octyl sulfide, diphenyl sulfide, thiodiglycol, ethylthioethanol, diisopropyl disulfide, di-n-butyl disulfide, di-n-hexyl disulfide, diacetyl disulfide, diethanol sulfide, di-tert-butyl trisulfide, dimethyl sulfoxide, dialkyl sulfide, dialkyl disulfide or diary! sulfide.

Suitable chain transfer agents b) are also mercaptans (compounds which comprise sulfur in the form of SH groups, also known as thiols). Preferred chain transfer agents b) are mono-, bi- and polyfunctional mercaptans, mercaptoalcohols and/or mercapto-carboxylic acids. Examples of these compounds are allyl thioglycolate, ethyl thioglycolate, cysteine, 2-mercaptoethanol, 1,3-mercaptopropanol, 3-mercaptopropane-1,2-diol, 1,4-mercaptobutanol, mercaptoacetic acid, 3-mercaptopropionic acid, 40 mercaptosuccinic acid, thioglycerol, thioacetic acid, thiourea, and alkyl mercaptans such as n-butyl mercaptan, n-hexyl mercaptan or n-dodecyl mercaptan.

Examples of bifunctional chain transfer agents which comprise two sulfur atoms in bound form are bifunctional thiols, for example dimercaptopropanesulfonic acid (sodium salt), dimercaptosuccinic acid, dimercapto-1-propanol, dimercaptoethane, dimercaptopropane, dimercaptobutane, dimercaptopentane, dimercaptohexane, ethylene glycol bis(thioglycolate) and butanediol bis(thioglycolate). Examples of polyfunctional chain transfer agents are compounds which comprise more than two sulfur atoms in bound form. Examples thereof are trifunctional and/or tetrafunctional mercaptans.

Further suitable chain transfer agents b) are also hypophosphorus acid and the salts thereof. These compounds include, for example, sodium hypophosphite, potassium hypophosphite or ammonium hypophosphite.

More preferably, in the case that the at least one chain transfer agent b) is simultaneously used as the solvent, alcohols and alkyl halides are used as chain transfer agents.

All chain transfer agents mentioned may be used individually or in combination with one another.

Preferably, the at least one chain transfer agent b) is selected from aldehydes, formic acid, alkyl halides, mono- and polyfunctional alcohols, hydroxycarboxylic acids, allyl compounds, mercaptans, hypophosphorus acid or the salts of hypophosphorus acid. More preferably the chain transfer agent b) is selected from formic acid, mercaptans or sodium hypophosphite.

The chain transfer agent b) can be used as such or dissolved in a solvent. In general, the chain transfer agent b) is used dissolved in a suitable solvent.

If present in the monomer composition (M), chain transfer agent b) is used preferably in an amount of from 0.05 to 25% by weight and more preferably from 0.1 to 10% by weight, based on the total weight of the monomer composition (M).

The proportions by weight of all monomer components present in the monomer composition (M) generally add up to 100%.

The amount of the chain transfer agent b) in the monomer composition (M) has a strong influence on the mean molecular weight of the polymer composition. When less chain transfer agent b) is used, this usually leads to higher mean molecular weights of the polymer formed. If, in contrast, greater amounts of chain transfer agent b) are used, this usually leads to a lower mean molecular weight.

The monomer composition (M) may optionally comprise at least one further monomer other than monomer components a) and b). It will be acknowledged by those skilled in the art that the at least one further monomer is different from monomer components a) and b).

Preferably, the monomer composition (M) additionally comprises at least one further monomer selected from
d) polyether acrylates, allyl alcohol alkoxylates
e) vinylaromatics,
f) esters of α,β-ethylenically unsaturated mono- and dicarboxylic acids with C₁-C₂₀-alkanols,
g) compounds having one free-radically polymerizable α,β-ethylenically unsaturated double bond and at least one cationogenic and/or cationic group per molecule,
h) esters of vinyl alcohol or allyl alcohol with C₁-C₃₀-monocarboxylic acids,
i) olefinically unsaturated monomers containing amide groups,
k) esters of α,β-ethylenically unsaturated mono- and dicarboxylic acids with C₂-C₃₀-alkanediols, amides of α,β-ethylenically unsaturated mono- and dicarboxylic acids with C₂-C₃₀-amino alcohols having a primary or secondary amino group,
l) α,β-ethylenically unsaturated nitriles,
m) olefinically unsaturated monomers having urea groups,

and mixtures thereof.

The further monomer components d) to m) are generally known to the person skilled in the art.

The at least one further monomer preferably is at least one monomer selected from polyether acrylates, allyl alcohol alkoxylates, vinylaromatics, esters of α,β-ethylenically unsaturated mono- and dicarboxylic acids with C₁-C₂₀-alcanols, compounds having one free-radically polymerizable α,β-ethylenically unsaturated double bond and at least one cationogenic group per molecule, compounds having one free-radically polymerizable α,β-ethylenically unsaturated double bond and at least one cationic group per molecule, compounds having one free-radically polymerizable α,β-ethylenically unsaturated double bond and at least one cationogenic and at least one cationic group per molecule, esters of vinyl alcohol or allyl alcohol with C₁-C₃₀-monocarboxylic acids, olefinically unsaturated monomers containing amide groups, esters of α,β-ethylenically unsaturated mono- and dicarboxylic acids with C₂-C₃₀-alkanediols, amides of α,β-ethylenically unsaturated mono- and dicarboxylic acids with C₂-C₃₀-amino alcohols having a primary or secondary amino group, α,β-ethylenically unsaturated nitrilesor olefinically unsaturated monomers having urea groups.

The monomer composition (M) may preferably comprise the at least one further monomer in an amount of 0% to 30% by weight, more preferably 0% to 20% by weight, especially 0% to 10% by weight, based on the total weight of the monomer composition (M). When the monomer composition (M) comprises at least one further monomer component, then preferably in an amount of 0.1% to 30% by weight, more preferably 1% to 20% by weight, especially 1.5% to 10% by weight, based on the total weight of the monomer composition (M). The proportions by weight of all monomer components present in the monomer composition (M) generally add up to 100%. In a specific embodiment, the monomer composition (M) does not comprise any further monomers.

Suitable polyether acrylates and allyl alcohol alkoxylates as monomer component d) are selected from compounds of the general formulae (I) and (II):

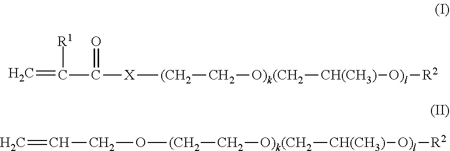

in which

the sequence of the alkylene oxide units is arbitrary,
k and l are each independently an integer from 0 to 1000, where the sum of k and l is at least 2, preferably at least 5,
R¹ is hydrogen or C₁-C₈-alkyl,
R² is hydrogen, C₁-C₃₀-alkyl, C₂-C₃₀-alkenyl or C₅-C₈-cycloalkyl,
X is O or a group of the formula NR³ in which R³ is H, alkyl, alkenyl, cycloalkyl, heterocycloalkyl, aryl or hetaryl.

In the formulae (I) and (II), k is preferably an integer from 1 to 500, more preferably 2 to 400, especially 3 to 250. Preferably, I is an integer from 0 to 100.

Preferably, R¹ in the formula (I) is hydrogen, methyl, ethyl, n-propyl, isopropyl, n-butyl, sec-butyl, tert-butyl, n-pentyl or n-hexyl, especially hydrogen, methyl or ethyl.

Preferably, R² in the formulae (I) and (II) is hydrogen, n-octyl, 1,1,3,3-tetramethylbutyl, ethylhexyl, n-nonyl, n-decyl, n-undecyl, tridecyl, myristyl, pentadecyl, palmityl, heptadecyl, octadecyl, nonadecyl, arachinyl, behenyl, lignoceryl, cerotinyl, melissyl, palmitoleyl, oleyl, linoleyl, linolenyl, stearyl, lauryl.

Preferably, X in the formula (I) is O or NH, especially O.

Suitable polyether acrylates according to formula (I) are, for example, the polycondensation products of the aforementioned α,β-ethylenically unsaturated mono- and/or dicarboxylic acids and the acid chlorides, acid amides and acid anhydrides thereof with polyetherols. Suitable polyetherols can be prepared easily by reacting ethylene oxide, propylene 1,2-oxide and/or epichlorohydrin with a starter molecule such as water or a short-chain alcohol R²-OH. The alkylene oxides can be used individually, alternately in succession, or as a mixture. The polyether acrylates I.a) can be used alone or in mixtures to prepare the polymers used in accordance with the invention.

Suitable allyl alcohol alkoxylates according to formula (II) are, for example, the etherification products of allyl chloride with appropriate polyetherols. Suitable polyetherols can be prepared easily by reacting ethylene oxide, propylene-1,2-oxide and/or epichlorohydrin with a starter alcohol R²-OH. The alkylene oxides can be used individually, alternately in succession, or as a mixture. The allyl alcohol alkoxylates (II) can be used alone or in mixtures to prepare the polymers used in accordance with the invention.

Monomer components d) used are especially methyl diglycol acrylate, methyl diglycol methacrylate, ethyl diglycol acrylate or ethyl diglycol methacrylate. Preference is given to ethyl diglycol acrylate.

Preferred monomer components e) are styrene, 2-methylstyrene, 4-methylstyrene, 2-(n-butyl)styrene, 4-(n-butyl)styrene or 4-(n-decyl)styrene. Particular preference is given to styrene or 2-methylstyrene, especially styrene.

Suitable monomer components f) are, for example, methyl (meth)acrylate, methyl ethacrylate, ethyl (meth)acrylate, ethyl ethacrylate, n-propyl (meth)acrylate, isopropyl (meth)acrylate, n-butyl (meth)acrylate, tert-butyl (meth)acrylate, tert-butyl ethacrylate, n-pentyl (meth)acrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate, n-decyl (meth)acrylate, n-undecyl (meth)acrylate, tridecyl (meth)acrylate, myristyl (meth)acrylate, pentadecyl (meth)acrylate, palmityl (meth)acrylate, heptadecyl (meth)acrylate, nonadecyl (meth)acrylate, arachinyl (meth)acrylate, behenyl (meth)acrylate, lignoceryl (meth)acrylate, cerotinyl (meth)acrylate, melissyl (meth)acrylate, palmitoleyl (meth)acrylate, oleyl (meth)acrylate, linoleyl (meth)acrylate, linolenyl (meth)acrylate, stearyl (meth)acrylate or lauryl (meth)acrylate.

The cationogenic and/or cationic groups of monomer component g) are preferably nitrogen-containing groups such as primary, secondary or tertiary amino groups, or quaternary ammonium groups. Preferably, the nitrogen-containing groups are tertiary amino groups or quaternary ammonium groups. Charged cationic groups can be produced from the amine nitrogens either by protonation or by quaternization with acids or alkylating agents. Examples of these include carboxylic acids such as lactic acid, or mineral acids such as phosphoric acid, sulfuric acid or hydrochloric acid, and examples of alkylating agents include C₁-C₄-alkyl halides or sulfates, such as ethyl chloride, ethyl bromide, methyl chloride, methyl bromide, dimethyl sulfate or diethyl sulfate. A protonation or quaternization may usually either precede or follow the polymerization.

Preferably, monomer component g) is selected from esters of α,β-ethylenically unsaturated mono- or dicarboxylic acids with amino alcohols which may be mono- or dialkylated on the amine nitrogen, amides of α,β-ethylenically unsaturated mono- or dicarboxylic acids with diamines having at least one primary or secondary amino group, N,N-diallylamine, N,N-diallyl-N-alkylamines and derivatives thereof, vinyl- or allyl-substituted nitrogen heterocycles or vinyl- or allyl-substituted heteroaromatic compounds.

Preferred monomer components g) are the esters of α,β-ethylenically unsaturated mono- and dicarboxylic acids with amino alcohols. Preferred amino alcohols are C₂-C₁₂-amino alcohols with C₁-C₈ mono- or dialkylation on the amine nitrogen. Suitable acid components of these esters are, for example, acrylic acid, methacrylic acid, fumaric acid, maleic acid, itaconic acid, crotonic acid, maleic anhydride or monobutyl maleate. The acid components used are preferably acrylic acid or methacrylic acid.

Preferred monomer components g) are N-methylaminoethyl (meth)acrylate, N-ethylaminoethyl (meth)acrylate, N-(n-propyl)aminoethyl (meth)acrylate, N-(tert-butyl)aminoethyl (meth)acrylate, N,N-dimethylaminomethyl (meth)acrylate, N,N-dimethylaminoethyl (meth)acrylate, N,N-diethylaminomethyl (meth)acrylate, N,N-diethylaminoethyl (meth)acrylate, N, N-d imethylami nopropyl (meth)acrylate, N,N-diethylaminopropyl (meth)acrylate or N,N-dimethylaminocyclohexyl (meth)acrylate.

Suitable monomer components g) are additionally the amides of the aforementioned α,β-ethylenically unsaturated mono- and dicarboxylic acids with diamines having at least one primary or secondary amino group. Preference is given to diamines having one tertiary amino group and one primary or secondary amino group.

Examples of preferred monomer components g) are N-[tert-butylaminoethyl](meth)acrylamide, N-[2-(dimethylamino)ethyl]acrylamide, N-[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide, N-[4-(dimethylamino)butyl]methacrylamide, N-[2-(diethylamino)ethyl]acrylamide, N-[4-(dimethylamino)cyclohexyl]acrylamide or N-[4-(dimethylamino)cyclohexyl]meth-acrylamide.

In a suitable embodiment, monomer component g) comprises, as vinyl-substituted heteroaromatic compound, at least one N-vinylimidazole compound or at least one N-vinyl pyridine compound. In a specific embodiment, monomer component g) is selected from N-vinylimidazole compounds, N-vinyl pyridine compounds and mixtures comprising at least one N-vinylimidazole compound or at least one N-vinyl pyridine compound.

Suitable N-vinylimidazole compounds are compounds of the formula (III):

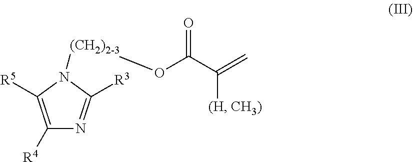

in which R³ to R⁵ are each independently hydrogen, C₁-C₄-alkyl or phenyl. Preferably, R¹ to R³ are hydrogen.

Additionally suitable are N-vinylimidazole compounds of the general formula (IV):

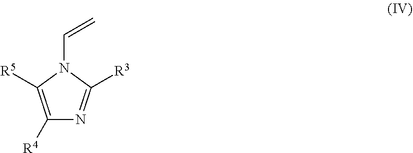

in which R³ to R⁵ are each independently hydrogen, C₁-C₄-alkyl or phenyl.

Examples of compounds of the general formula (IV) are given in Table 1 below:

TABLE 1

| R³ | R⁴ | R⁵ |
|---|---|---|
| H | H | H |
| Me | H | H |
| H | Me | H |
| H | H | Me |
| Me | Me | H |
| H | Me | Me |
| Me | H | Me |
| Ph | H | H |
| H | Ph | H |
| H | H | Ph |
| Ph | Me | H |
| Ph | H | Me |
| Me | Ph | H |
| H | Ph | Me |
| H | Me | Ph |
| Me | H | Ph |

Me = methyl
Ph = phenyl

Preferred monomer components g) are 1-vinylimidazole (N-vinylimidazole) and mixtures comprising N-vinylimidazole.

Suitable monomer components g) are also the compounds obtainable by protonating or quaternizing the aforementioned N-vinylimidazole compounds. Examples of such charged monomer components g) are quaternized vinylimidazoles, in particular 3-methyl-1-vinylimidazolium chloride, 3-methyl-1-vinylimidazolium methylsulfate or 3-methyl-1-vinylimidazolium ethylsulfate. Suitable acids and alkylating agents are those listed above. Preference is given to a protonation or quaternization after the polymerization.

Suitable monomer components g) are additionally vinyl- and allyl-substituted nitrogen heterocycles other than vinylimidazoles, such as 2- or 4-vinylpyridine, 2- or 4-allylpyridine, or the salts thereof.

Suitable monomer components h) are, for example, methyl vinyl ester, ethyl vinyl ester, n-propyl vinyl ester, isopropyl vinyl ester, n-butyl vinyl ester, tert-butyl vinyl ester, n-pentyl vinyl ester, n-hexyl vinyl ester, n-heptyl vinyl ester, n-octyl vinyl ester, 1,1,3,3-tetramethylbutyl vinyl ester, ethylhexyl vinyl ester, n-nonyl vinyl ester, n-decyl vinyl ester, n-undecyl vinyl ester, tridecyl vinyl ester, myristyl vinyl ester, pentadecyl vinyl ester, palmityl vinyl ester, heptadecyl vinyl ester, octadecyl vinyl ester, nonadecyl vinyl ester, arachinyl vinyl ester, behenyl vinyl ester, lignoceryl vinyl ester, cerotyl vinyl ester, melissyl vinyl ester, palmitoleyl vinyl ester, oleyl vinyl ester, linoleyl vinyl ester, linolenyl vinyl ester, stearyl vinyl ester or lauryl vinyl ester.

Suitable monomer components i) are compounds of the general formula (V):

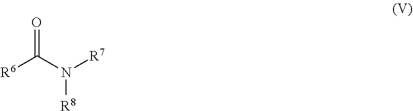

where

one of the R⁶ to R⁹ radicals is a group of the formula CH₂═CR⁹where R⁹═H or C₁-C₄-alkyl and the other R⁶ to R⁹ radicals are each independently H, alkyl, cycloalkyl, heterocycloalkyl, aryl or heteroaryl,

where R⁶ and R⁷ together with the amide group to which they are bonded may also be a lactam having 5 to 8 ring atoms,

where R⁷ and R⁹ together with the nitrogen atom to which they are bonded may also be a five- to seven-membered heterocycle.

Preferably, the compounds of monomer component i) are selected from primary amides of α,β-ethylenically unsaturated monocarboxylic acids, N-vinylamides of saturated monocarboxylic acids, N-vinyllactams, N-alkyl- or N,N-dialkylamides of α,β-ethylenically unsaturated monocarboxylic acids.

Preferred monomer components i) are N-vinyllactams and derivatives thereof which may have, for example, one or more C₁-C₆-alkyl substituents such as methyl, ethyl, n-propyl, isopropyl, n-butyl, sec-butyl, tert-butyl, etc. These include, for example, N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, etc.

Particular preference is given to using N-vinylpyrrolidone and/or N-vinylcaprolactam.

Suitable monomer components i) are additionally acrylamide or methacrylamide.

Suitable N-alkyl- and N,N-dialkylamides of α,β-ethylenically unsaturated monocarboxylic acids are, for example, methyl(meth)acrylamide, methylethacrylamide, ethyl(meth)acrylamide, ethylethacrylamide, n-propyl(meth)acrylamide, isopropyl-(meth)acrylamide, n-butyl(meth)acrylamide, tert-butyl(meth)acrylamide, tert-butyl-ethacrylamide, n-pentyl(meth)acrylamide, n-hexyl(meth)acrylamide, n-heptyl-(meth)acrylamide, n-octyl(meth)acrylamide, 1,1,3,3-tetramethylbutyl(meth)acrylamide, ethylhexyl(meth)acrylamide, n-nonyl(meth)acrylamide, n-decyl(meth)acrylamide, n-undecyl(meth)acrylamide, tridecyl(meth)acrylamide, myristyl(meth)acrylamide, pentadecyl(meth)acrylamide, palmityl(meth)acrylamide, heptadecyl(meth)acrylamide, nonadecyl(meth)acrylamide, arachinyl(meth)acrylamide, behenyl(meth)acrylamide, lignoceryl(meth)acrylamide, cerotinyl(meth)acrylamide, melissyl(meth)acrylamide, palmitoleyl(meth)acrylamide, oleyl(meth)acrylamide, linoleyl(meth)acrylamide, linolenyl(meth)acrylamide, stearyl(meth)acrylamide, lauryl(meth)acrylamide, N-methyl-N-(n-octyl)(meth)acrylamide or N,N-di(n-octyl)(meth)acrylamide.

Open-chain N-vinylamide compounds suitable as monomer components i) are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methyl-propionamide or N-vinylbutyramide. Preference is given to using N-vinylformamide.

Suitable esters of α,β-ethylenically unsaturated mono- and dicarboxylic acids with C₂-C₃₀-alkanediols as monomer components k) are 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, 4-hydroxybutyl acrylate, 4-hydroxybutyl methacrylate, 6-hydroxyhexyl acrylate, 6-hydroxyhexyl methacrylate, 3-hydroxy-2-ethylhexyl acrylate, 3-hydroxy-2-ethylhexyl methacrylate, etc.

Suitable amides of α,β-ethylenically unsaturated mono- and dicarboxylic acids with C₂-C₃₀-amino alcohols having a primary or secondary amino group as monomer components k) are 2-hydroxyethylacrylamide, 2-hydroxyethylmethacrylamide, 2-hydroxyethylethacrylamide, 2-hydroxypropylacrylamide, 2-hydroxypropylmethacrylamide, 3-hydroxy-propylacrylamide, 3-hydroxypropylmethacrylamide, 3-hydroxybutylacrylamide, 3-hydroxybutylmethacrylamide, 4-hydroxybutylacrylamide, 4-hydroxybutylmethacrylamide, 6-hydroxyhexylacrylamide, 6-hydroxyhexyl-methacrylamide, 3-hydroxy-2-ethylhexylacrylamide or 3-hydroxy-2-ethylhexyl-methacrylamide.

Suitable monomer components l) are acrylonitrile or methacrylonitrile.

Suitable monomer components m) are N-vinylurea, N-allylurea or derivatives of imidazolidin-2-one. These comprise N-vinyl- and N-allylimidazolidin-2-one, N-vinyloxyethylimidazolidin-2-one, N-(2-(meth)acrylamidoethyl)imidazolidin-2-one, N-(2-(meth)acryloyloxyethyl)imidazolidin-2-one (i.e. 2-ureido(meth)acrylate), N-[2-((meth)acryloyloxyacetamido)ethyl]imidazolidin-2-one, etc.

In one embodiment, the monomer composition (M) comprises
60 to 80% by weight of the at least one olefinically unsaturated acid monomer a),
2 to 20% by weight of at least one chain transfer agent b), and
8 to 25% by weight of at least one further monomer selected from monomers d) to m),
where the proportions by weight of all monomer components present in the monomer composition (M) add up to 100%.

In one particularly preferred embodiment, the monomer composition (M) comprises
75 to 92% by weight of the at least one olefinically unsaturated acid monomer a), and
8 to 25% by weight of at least one chain transfer agent b),
where the proportions by weight of all monomer components present in the monomer composition (M) add up to 100%.

Radical polymerization processes as such and processes for preparing a polymer composition are known to those skilled in the art (see also below).

The radical polymerization can be carried out optionally in the presence of at least one free-radical initiator (P).

Free-radical initiators in the context of the invention are compounds that can produce radical species usually under mild conditions and promote radical reactions. These substances usually possess at least one group with weak atom—atom bonds that has small bond dissociation energies and can be cleaved thermolytically or photolytically. Suitable free-radical initiators are known to those skilled in the art. In principle, it is possible to use any of the free-radical initiators that are known to the person skilled in the art and/or that can be produced by known methods.

Useful free-radical initiators are in principle all initiators known for the free-radical polymerization of ethylenically unsaturated monomers. They are usually initiators based on organic or inorganic peroxides, azo initiators or so-called redox initiator systems. They are especially thermal initiators having a suitable half-life at the polymerization temperature.

Examples of suitable free-radical initiators (P) are specified below:
peroxide compounds: these include, for example, organic peroxides and hydroperoxides such as acetyl hydroperoxide, diacetyl peroxide, benzoyl hydroperoxide, dibenzoyl peroxide, lauroyl peroxide, dilauroyl peroxide, succinyl peroxide, tert-butyl peroxyisobutyrate, caproyl peroxide, cumyl hydroperoxide, dicumyl peroxide, di-tert-butyl peroxide, tert-butyl hydroperoxide, tert-amyl hydroperoxide, di-tert-amyl peroxide, tert-butyl peroxyacetate, tert-butyl peroxy-2-ethylhexanoate, tert-butyl peroxymaleate, tert-butyl peroxybenzoate, tert-butyl peroxyoctoate, tert-butyl peroxy neodecanoate, diisopropyl peroxydicarbamate, bis(o-toluoyl) peroxide, didecanoyl peroxide, dioctanoyl peroxide, tert-amyl peroxypivalate, tert-butyl peroxypivalate, diisopropyl peroxydicarbonate, dicyclohexyl peroxydicarbonate; inorganic peroxides such as hydrogen peroxide, peroxodisulfuric acid and salts thereof, such as ammonium, sodium and potassium peroxodisulfate;
azo compounds such as 2,2′-azobis(isobutyronitrile) (AIBN), 2,2′-azobis(2-methylbutyronitrile), 2,2′-azobis[2-methyl-N-(2-hydroxyethyl)propionamide], 1,1′-azobis(1-cyclohexanecarbonitrile), 2,2′-azobis(2,4-dimethylvaleronitrile), 2,2′-azobis-(N,N′-dimethylenisobutyroamidine), 2,2′-azobis-(N,N′-dimethyleneisobutyroamidine), 2,2′-azobis(2-methylpropioamidine), N-(3-hydroxy-1,1-bis-(hydroxy-methyl)propyl)-2-[1-(3-hydroxy-1,1-bis-(hydroxymethyl)propyl-carbamoyl)-1-methyl-ethylazo]-2-methyl-propionamide and N-(1-ethyl-3-hydroxypropyl)-2-[1-(1-ethyl-3-(hydroxy-propyl)carbamoyl)-1-methylethylazo]-2-methylpropionamide; 2,2′-azobis(2-cyano-2-butane), dimethyl-2,2′-azobis(dimethylisobutyrate), 4,4′-azobis(4-cyano-pentanoic acid), 1,1′-azobis(cyclohexanecarbanitrile), 2-(tert-butylazo)-2-cyanopropane, 2,2′-azobis[2-methyl-N-(1,1)-bis(hydroxymethyl)-2-(hydroxyethyl)-propionamide], 2,2′-azobis(2-methyl-N-hydroxyethyl)propionamide, 2,2′-azobis(N,N′-dimethylene-isobutyramidine) dihydrochloride, 2,2′-azobis(2-amidinopropane) dihydrochloride, 2,2′-azobis(N,N′-dimethyleneisobutyramine), 2,2′-azobis[2-methyl-N-(1,1-bis-(hydroxymethyl)-2-hydroxyethyl)propionamide], 2,2′-azobis[2-methyl-N-(1,1-bis-(hydroxymethypethyl)propionamide], 2,2′-azobis[2-methyl-N-(2-hydroxy-ethyl)-propionamide], 2,2′-azobis(isobutyramide) anhydrate, 2,2′-azobis(2,2,4-trimethyl-pentane), 2,2′-azobis(2-methylpropane);
redox initiators: this is understood to mean initiator systems which comprise an oxidizing agent, for example peroxodisulfuric acid and salts thereof, such as ammonium, sodium and potassium peroxodisulfate, hydrogen peroxide or an organic peroxide such as tert-butyl hydroperoxide, and a reducing agent. As the reducing agent, the initiator systems preferably comprise a sulfur compound which is especially selected from sodium hydrogensulfite, sodium hydroxymethanesulfinate and the hydrogensulfite adduct to acetone. Further suitable reducing agents are nitrogen and phosphorus compounds such as phosphorous acid, hypophosphites and phosphinates, di-tert-butyl hyponitrite and dicumyl hyponitrite, and also hydrazine and hydrazine hydrate and ascorbic acid. In addition, redox initiator systems may comprise an addition of small amounts of redox metal salts such as iron salts, vanadium salts, copper salts, chromium salts or manganese salts; suitable redox initiator systems are, for example, the ascorbic acid/iron(II) sulfate/sodium peroxodisulfate redox initiator system, tert-butyl hydroperoxide/sodium disulfite, tert-butyl hydroperoxide/sodium hydroxymethane sulfinate and hydrogen peroxide/Cu^{I}.

The abovementioned initiators can also be used in any combinations.

Preferably, the at least one free-radical initiator (P) is selected from acetyl hydroperoxide, diacetyl peroxide, benzoyl hydroperoxide, dibenzoyl peroxide, lauroyl peroxide, dilauroyl peroxide, succinyl peroxide, tert-butyl peroxyisobutyrate, tert-butyl hydroperoxide, di-tert-butyl peroxide, tert-amyl hydroperoxide, di-tert-amyl peroxide, tert-butyl peroxyacetate, tert-butyl peroxymaleate, diisopropyl peroxydicarbamate, tert-amyl peroxypivalate, tert-butyl peroxypivalate, diisopropyl peroxydicarbonate, 2,2′-azobis(isobutyronitrile), 2,2′-azobis(2-methylbutyronitrile), 2,2′-azobis(2,4-di methyl-valeronitrile), 2,2′-azobis(2-amidinopropane) dihydrochloride, hydrogen peroxide, peroxodisulfuric acid, ammonium peroxodisulfate or sodium peroxodisulfate.

If present, the amount of the at least one free-radical initiator (P) used typically ranges from 0.1 to 20% by weight, in particular from 0.2 to 10% by weight and especially from 0.5 to 7% by weight, based on the total amount of monomers to be polymerized.

The at least one free-radical initiator (P) can be used as such or dissolved in a solvent. Preference is given to using the at least one free-radical initiator (P) dissolved in a suitable solvent. Suitable solvents are those specified for the polymerization below.

According to the inventive process, the radical polymerization is carried out in the presence of at least one polyether compound (PE).

Suitable polyether compounds (PE) are generally known to those skilled in the art.

For example, suitable polyether compounds (PE) are polyetherols having a number-average molecular weight of at least 200 g/mol and the mono- and di-(C₁-C₆-alkyl) ethers thereof.

Suitable polyetherols and the mono- and di-(C₁-C₆-alkyl) ethers thereof may be linear or branched, preferably linear. Suitable polyetherols and the mono- and di-(C₁-C₆-alkyl) ethers thereof usually have a number-average molecular weight in the range from about 200 g/mol to 100 000 g/mol, preferably 300 g/mol to 50 000 g/mol, more preferably 500 g/mol to 40 000 g/mol. Suitable polyetherols are, for example, water-soluble or water-dispersible non-ionic polymers having repeat alkylene oxide units. Preferably, the proportion of repeat alkylene oxide units is at least 30% by weight, based on the total weight of the compound. Suitable polyetherols are polyalkylene glycols, such as polyethylene glycols, polypropylene glycols, polytetrahydrofurans and alkylene oxide copolymers. Suitable alkylene oxides for preparation of alkylene oxide copolymers are, for example, ethylene oxide, propylene oxide, epichlorohydrin, 1,2-butylene oxide and 2,3-butylene oxide. Suitable examples are copolymers of ethylene oxide and propylene oxide, copolymers of ethylene oxide and butylene oxide, and copolymers of ethylene oxide, propylene oxide and at least one butylene oxide. The alkylene oxide copolymers may comprise the copolymerized alkylene oxide units in random distribution or in the form of blocks. Preferably, the proportion of repeat units derived from ethylene oxide in the ethylene oxide/propylene oxide copolymers is 40% to 99% by weight. Particularly preferred polyether compounds (PE) are ethylene oxide homopolymers and ethylene oxide/propylene oxide copolymers.

Suitable polyether compounds (PE) are additionally the mono- and di-(C₁-C₂-alkyl) ethers of the above-described polyetherols. Preference is given to polyalkylene glycol monomethyl ethers and polyalkylene glycol dimethyl ethers.

Suitable polyether compounds (PE) are additionally surfactants containing polyether groups. In general, non-ionic and ionic surfactants having at least one non-polar group and at least one polar group and comprising a polyether group are suitable.

The surfactants containing polyether groups are preferably selected from alkyl polyoxyalkylene ethers, aryl polyoxyalkylene ethers, alkylaryl polyoxyalkylene ethers, alkoxylated animal, alkoxylated animal oils, alkoxylated vegetable fats, alkoxylated vegetable oils, fatty amine alkoxylates, fatty acid amide alkoxylates, fatty acid diethanolamide alkoxylates, polyoxyethylene sorbitan fatty acid esters, alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride (ether) sulfates, fatty acid amide ether sulfates or polyoxyalkylene sorbitan fatty acid esters.

The preferred non-ionic surfactants containing polyether groups are, for example:
alkyl polyoxyalkylene ethers which derive from low molecular weight C₃-C₆-alcohols or from C₇-C₃₀-fatty alcohols. The ether component here may be derived from ethylene oxide units, propylene oxide units, 1,2-butylene oxide units, 1,4-butylene oxide units and random copolymers and block copolymers thereof. Suitable non-ionic surfactants comprise, inter alia, surfactants of the general formula (VI):

R¹⁰—O—(CH₂CH₂O)ₓ—(CHR¹¹CH₂O)_{y}—R¹² (VI)

in which
R¹⁰ is a linear or branched alkyl radical having 6 to 22 carbon atoms,
R¹¹ and R¹² are each independently hydrogen or a linear or branched alkyl radical having 1 to 10 carbon atoms or H, where R¹² is preferably methyl, and
x and y are each independently 0 to 300. Preferably, x=1 to 100 and y=0 to 30.

These especially also include fatty alcohol alkoxylates and oxo alcohol alkoxylates, such as isotridecyl alcohol polyoxyethylene ethers and oleyl alcohol polyoxyethylene ethers.
surfactants containing hydroxyl groups of the general formula (VII):

R¹³—O—(CH₂CH₂O)ₛ—(CH₂CH₂CH₂O)ₜ—(CH₂CH₂CH₂CH₂O)ᵤ—(CH₂CHR¹⁴O)ᵥ—CH₂CH(OH)R¹⁵ (VII)

where

the sequence of the alkylene oxide units in the compounds of the formula (VII) is arbitrary,
s, t, u and v are each independently an integer from 0 to 500, where the sum of s, t, u and v is >0,
R¹³ and R¹⁵ are each independently a straight-chain or branched saturated C₁-C₄₀- alkyl radical or a mono- or polyunsaturated C₂-C₄₀-alkenyl radical, and
R¹⁴ is selected from methyl, ethyl, n-propyl, isopropyl and n-butyl.

In the compounds of the general formula (VII), the sum of s, t, u and v is preferably a value of 10 to 300, more preferably of 15 to 200 and especially of 20 to 150.

Preferably, t and u are each 0. In that case, the sum of s and v is preferably a value of 10 to 300, more preferably of 15 to 200 and especially of 20 to 150.

In the compounds of the general formula (VII), R¹³ and R¹⁵ are each independently a straight-chain or branched saturated C₂-C₃₀-alkyl radical. At the same time, R¹³ and R¹⁵ may also be mixtures of different alkyl radicals.

In the compounds of the general formula (VII), R¹⁴ is preferably methyl or ethyl, especially methyl.

A preferred embodiment comprises surfactants containing hydroxyl groups of the general formula (VII.1)

R¹³—O—(CH₂CH₂O)ₛ—(CH₂CH(CH₃)O)ᵥ—CH₂CH(OH)R¹⁵ (VII.1)

where

the sequence of the —(CH₂CH₂O)— and the —(CH₂CH(CH₃)O)— units is arbitrary,

s and v are each independently an integer from 0 to 500, where the sum of s and v is >0,

R¹³ and R¹⁵ are each independently a straight-chain saturated C₁-C₃₀-alkyl radical or a branched saturated C₃-C₃₀-alkyl radical or a mono- or polyunsaturated C₂-C₃₀-alkenyl radical.

In the compounds of the general formula (VII.1), the sum of s and v is preferably a value of 10 to 300, more preferably of 15 to 200 and especially of 20 to 150.

The group of these non-ionic surfactants includes, for example, hydroxy mixed ethers of the general formula (C₆₋₂₂-alkyl)-CH(OH)CH₂O-(EO)_{20,120}-(C₂₋₂₆-alkyl) with EO=ethylene oxide.
alcohol polyoxyalkylene esters of the general formula (VIII):

R¹⁶—O—(CH₂CH₂O)ₚ—(CH₂CHR¹⁷O)_{q}—C(═O)R¹⁸ (VIII)

where

the sequence of the alkylene oxide units in the compounds of the formula (VIII) is arbitrary,
p and q are each independently an integer from 0 to 500, where the sum of p and q is >0,
R¹⁶ and R¹⁸ are each independently a straight-chain or branched saturated C₁-C₄₀-alkyl radical or a mono- or polyunsaturated C₂-C₄₀-alkenyl radical, and
R¹⁷ is selected from methyl, ethyl, n-propyl, isopropyl and n-butyl.

In the compounds of the general formula (VIII), the sum of p and q is preferably a value of 10 to 300, more preferably of 15 to 200 and especially of 20 to 150.

In the compounds of the general formula (VIII), R¹⁶ and R¹⁸ are each independently a straight-chain or branched saturated C₄-C₃₀-alkyl radical. At the same time, R¹⁶ and R¹⁸ may also be mixtures of different alkyl radicals.

In the compounds of the general formula (VIII), R¹⁷ is preferably methyl or ethyl, especially methyl.

These include, for example, lauryl alcohol polyoxyethylene acetate.
alkylaryl alcohol polyoxyethylene ethers, for example octylphenol polyoxyethylene ethers,
alkoxylated animal fats, alkoxylated animal oils, alkoxylated vegetable fats, alkoxylated vegetable oils, for example corn oil ethoxylates, castor oil ethoxylates, tallow fat ethoxylates,
alkylphenol alkoxylates, for example ethoxylated isooctyl-, octyl- or nonylphenol, tributylphenol polyoxyethylene ether,
fatty amine alkoxylates, fatty acid amide and fatty acid diethanolamide alkoxylates, especially ethoxylates thereof,
polyoxyalkylene sorbitan fatty acid esters.

One example of an alkyl polyether sulfate is sodium dodecyl poly(oxyethylene) sulfate (sodium lauryl ether sulfate, SLES). A preferred, commercially available modified fatty alcohol polyglycol ether is a polyethylene oxide CₓH₂ₓ₊₁/C_{y}H_{2y+1}-terminated at either end and having a free OH group and x, y=6 to 14.

The weight ratio of the monomer mixture (M) to the at least one polyether compound (PE) is preferably in the range from 1:10 to 10:1, more preferably in the range from 1:8 to 8:1 and especially in the range from 1:5 to 5:1.

The at least one polyether compound (PE) generally does not have any copolymerizable double bond and affords specific polymer compositions having advantageous properties. Without being bound to a theory, this may be attributable, for example, to hydrogen bonding between the at least one polymer on the one hand and the at least one polyether compound (PE) on the other hand, leading to polymer-polyether complex formation in the polymer composition.

Thus, in contrast to the process according to WO 2014/090743, the at least one polyether compound (PE) usually does not undergo any radical polymerization reactions and usually does not copolymerize with the at least one olefinically unsaturated acid monomer a). However, if the at least one polyether compound copolymerizes with the at least one olefinically unsaturated acid monomer a), then preferably only very small amounts of less than 1% by weight, preferably less than 0.5% by weight and especially less than 0.1% by weight, based on the total weight of the at least one polyether compound (PE), copolymerize with the at least one olefinically unsaturated acid monomer a). Particularly preferably, the at least one polyether compound (PE) does not copolymerize at all with the at least one olefinically unsaturated acid monomer a).

In one embodiment, the monomer composition (M) and the at least one polyether compound (PE) do not comprise any olefinically unsaturated polyether macromonomers, such as those defined in WO 2014/090743.

The radical polymerization can be carried out in the presence of at least one solvent (S) selected from water, C₁-C₆-alkanols, polyols other than the at least one polyether compound (PE), the mono- and dialkyl ethers thereof, aprotic polar solvents and mixtures thereof. Suitable solvents (S) are known to the person skilled in the art.

Suitable aprotic polar solvents are pyrrolidones and pyrrolidone derivatives. These especially include 2-pyrrolidone (y-butyrolactam) and N-methylpyrrolidone.

Suitable polyols and the mono- and dialkyl ethers thereof also comprise alkylene glycol mono-(C₁-C₄-alkyl) ethers, alkylene glycol di-(C₁-C₄-alkyl) ethers, oligoalkylene glycols having a number-average molecular weight of less than 200 g/mol and the mono-(C₁-C₄-alkyl) ethers and di-(C₁-C₄-alkyl) ethers thereof.

The at least one solvent (S) is preferably selected from water, methanol, ethanol, n-propanol, isopropanol, n-butanol, ethylene glycol, ethylene glycol mono-(C₁-C₄-alkyl) ethers, ethylene di-(C₁-C₄-alkyl) glycol ethers, 1,2-propylene glycol, 1,2-propylene glycol mono-(C₁-C₄-alkyl) ethers, 1,2-propylene glycol di-(C₁-C₄-alkyl) ethers, glycerol, polyglycerols, 2-pyrrolidone, N-methylpyrrolidone, oligoalkylene glycols having a number-average molecular weight of less than 200 g/mol and mixtures thereof.

Suitable oligoethylene glycols are commercially available under the CTFA designations PEG-6, PEG-8, PEG-12, PEG-6-32, PEG-20, PEG-150, PEG-7M, PEG-12M and PEG-115M. These especially include the Pluriol E ® products from BASF SE. Suitable alkyl polyalkylene glycols are the corresponding Pluriol A . . . E® products from BASF SE.

Preference is given to the isomeric dipropylene glycols such as 1,1′-oxydi-2-propanol, 2,2′-oxydi-1-propanol, 2-(2-hydroxypropoxy)-1-propanol and mixtures thereof.

The at least one solvent (S) is more preferably selected from water, ethanol, n-propanol, isopropanol, ethylene glycol, diethylene glycol, 1,2-propylene glycol, 1,2-dipropylene glycol, glycerol, oligoglycerol, polyglycerol and mixtures thereof.

In a specific embodiment, the at least one solvent (S) used is selected from water and a mixture of water and at least one further solvent other than water, selected from ethanol, n-propanol, isopropanol, ethylene glycol, diethylene glycol, 1,2-propylene glycol, 1,2-dipropylene glycol, glycerol, oligoglycerol, polyglycerol and mixtures thereof.

In a specific embodiment, the radical polymerization is carried out in the presence of at least one solvent (S) comprising of at least 50% by weight, preferably at least 75% by weight, especially at least 90% by weight, based on the total weight of the at least one solvent (S), of water. More particularly, the radical polymerization is carried out in the presence of a solvent (S) consisting entirely of water.

Preferably, the reaction mixture comprising the at least one olefinically unsaturated acid monomer a), optionally the at least one chain transfer agent b), the at least one polyether compound (PE), optionally the at least one free-radical initiator (P), the at least one solvent (S) and optionally the at least one further monomer comprises at least 10% by weight, preferably at least 15% by weight, especially at least 20% by weight, based on the total weight of said reaction mixture, of the at least one solvent (S).

Preferably, the reaction mixture comprising the at least one olefinically unsaturated acid monomer a), optionally the at least one chain transfer agent b), the at least one polyether compound (PE), optionally the at least one free-radical initiator (P), the at least one solvent (S) and optionally the at least one further monomercomprises 10% to 90% by weight, preferably 15% to 80% by weight, especially 20% to 70% by weight, based on the total weight of said reaction mixture, of the at least one solvent (S).

If the polymer composition is prepared using at least one solvent (S), the weight ratio of the at least one polyether compound (PE) to the at least one solvent (S) is preferably in the range from 0.3:1 to 5:1, more preferably in the range from 0.5:1 to 3:1.

In an alternative preferred embodiment, the radical polymerization is carried out in the presence of at least one solvent (S) and the reaction mixture comprises the at least one olefinically unsaturated acid monomer a), optionally the at least one chain transfer agent b), the at least one polyether compound (PE), optionally the at least one free-radical initiator (P), the at least one solvent (S), optionally the at least one further monomer and said reaction mixture comprises less than 50% by weight, preferably less than 30% by weight, especially less than 10% by weight, based on the total weight of said reaction mixture, of the at least one solvent (S).

In this alternative preferred embodiment, said reaction mixture preferably comprises at least 0.1% by weight, preferably at least 0.5% by weight, especially at least 1% by weight, based on the total weight of said reaction mixture, of the at least one solvent (S).

The radical polymerization can be carried out at any temperature. Preferably, the radical polymerization is carried out at a temperature in the range from 20 to 150° C., more preferably from 30 to 120° C., especially from 50 to 90° C.

The radical polymerization can be carried out at ambient pressure or reduced or elevated pressure. Preferably, the radical polymerization is carried out at ambient pressure.

The polymerization is usually carried out at constant temperature, but can also be varied during the radical polymerization if required. Preferably, the polymerization temperature is kept very substantially constant within the at least one continuously operated back-mixed reactor. In the inventive process, the polymerization temperature varies typically within the range from 20 to 150° C. Preferably, the polymerization temperature varies within the range from 30 to 120° C. and especially within the range from 50 to 90° C. If the polymerization is not conducted under elevated pressure and at least one optional solvent (S) has been added to the reaction mixture, the at least one solvent (S) determines the maximum reaction temperature via the corresponding boiling temperatures.

The polymer composition obtained in the inventive process preferably comprises more than 1 mmol/g, more preferably more than 1.3 mmol/g of acid groups. The polymer composition obtained in the inventive process preferably comprises less than 15 mmol/g of acid groups. The polymer composition obtained in the inventive process especially comprises 1.5 mmol/g to 15 mmol/g of acid groups.

Preferably, the acid groups of the polymer composition obtained in the inventive process are in non-neutralized form.

The weight average molecular weight M_{w} of the polymer composition obtained in the inventive process is usually in the range from 1 000 to 150 000 g/mol. The weight average molecular weights M_{w} are measured using gel permeation chromatography (GPC). Neutralized polyacrylic acid was used as standard in the measurements.

If the radical polymerization is carried out in the presence of at least one solvent (S), the polymer composition preferably comprises less than 50% by weight, preferably less than 30% by weight, especially less than 10% by weight, based on the total weight of said reaction mixture, of the at least one solvent (S).

In this case, the polymer composition preferably comprises at least 0.1% by weight, preferably at least 0.5% by weight, especially at least 1% by weight, based on the total weight of said reaction mixture, of the at least one solvent (S).

In one embodiment, the solids content of the polymer composition is preferably greater than 50% by weight, more preferably greater than 70% by weight and especially preferably greater than 90% by weight, based on the total weight of the said reaction mixture.

Within the context of the present invention, the term “solids content” refers to the total amount of components in the polymer composition, which are usually present as a solid after the radical polymerization.

In the inventive process, the radical polymerization is carried out in at least one reactor, wherein
i) the at least one reactor is operated in batch or semibatch mode,
ii) the at least one reactor comprises a volume-based heat removal power (A) of at least 3 kW/(m³·K), and
iii) the at least one reactor has a volume of at least 10 I.

In the context of the present invention, the terms “batch operation” and “batch mode” refer to a process in which all starting materials are charged into the respective employed reactor before start of the reaction. After starting the reaction, the reaction mixture is held in the reactor for a defined period and then discharged. In the context of the present invention, the terms “semibatch operation” and “semibatch mode” refer to a process in which optionally part of the starting materials are charged into the respective employed reactor before start of the reaction. After starting the reaction, the reaction mixture is held in the reactor for a defined period during which further materials are added to the reaction mixture. After a defined period, the reaction mixture is discharged from the reactor.

In the context of the present invention, the terms “continuously operated” or “continuous operation” refer to a process in which all materials that are being processed and produced are usually in steady motion throughout the respective employed reactor as a flowing stream and usually undergo chemical reactions or can be subject to mechanical or heat treatment. In contrast to batch or semibatch reactors, which are typically operated for a given short duration, continuously operated reactors can be operated for an unpredetermined long duration and are usually operated without interruptions, except for infrequent maintenance shutdowns.

In the context of the present invention, the terms “back-mixed reactor” or “back-mixing” refer to a special type of reactor in which volume elements are mixed with preceding and following volume elements. This can be achieved, for example by implementing suitable internal mixing elements into the reactor and/or by recycling at least part of the reaction mixture. Specifically, in a reactor in semi-batch operation, volume elements already charged to the reactor (preceding volume elements in the dimension time) are mixed with added volume elements (following volume elements in the dimension time) during the course of the reaction. Hence, in semibatch mode, a reactor is back-mixed in time.

In principle, any reactor in batch or semibatch mode can be used in the inventive process as long as it provides a sufficient volume-based heat removal power. Within the inventive process, it is preferred that the reactor is operated in semibatch mode. Preferably, exactly one reactor is employed within the inventive process. Preferably, the at least one reactor used in the inventive process is a loop reactor.

In one embodiment of the present invention, the inventive process, in particular the radical polymerization, is not carried out in any continuously operated reactor and/or any reactor which is back-mixed in space (“back-mixed reactor in space”). More preferably, the inventive process, in particular the radical polymerization, is not carried out in at least one continuously operated back-mixed reactor.

It is also preferred that the at least one reactor has a volume-based heat removal power (A) of at least 5 kW/(m³·K), preferably of at least 10 kW/(m³·K) and especially at least 25 kW/(m³·K).

Furthermore, it is preferred that the reactor has a volume of at least 100 I, preferably of at least 500 I, more preferably of at least 2000 I.

Furthermore, it is preferred that the batch comprising the polymer composition and/or the monomer composition (M) has a size of at least 100 I, preferably of at least 500 I, more preferably of at least 1000 I, inside of the reactor during operation in batch or semibatch mode.

The reactor employed within the inventive process usually has a required heat removal power to remove heat of reaction (B), wherein the respective value of (B) does not exceed the respective value of the volume-based heat removal power (A). It is preferred that the ratio of (B) to (A) (“B/A ratio”) is <1, more preferably <0.7, most preferably <0.5.

In one embodiment of the present invention, it is preferred that the at least one reactor comprises a volume-based heat removal power (A) of at least 5 kW/(m³·K), a volume of at least 500 I and the batch comprising the polymer composition and/or the monomer composition (M) has a size of at least 100 I inside of the reactor during operation in batch or semibatch mode. It is preferred within this embodiment that the reactor is operated in semibatch mode.

In the context of the present invention, a “loop reactor” comprises a tubular reactor which enables recycling of the reaction mixture. The loop reactor is operated in batch or semibatch mode according to the inventive process and preferably has a volume-based heat removal power (A) of at least 5 kW/m³·K, preferably at least 10 kW/m³·K and especially at least 25 kW/m³·K. This can be achieved, for example, by using tube bundle or plate heat exchangers, among others.

In a preferred embodiment, the loop reactor comprises an apparatus for circulating the reaction medium. In particular, such devices are gear pumps.

The loop reactor preferably comprises at least one reaction zone with internal cooling and mixing elements over which the reaction medium flows by convection in the mixing section. This can be achieved, for example, by integration of a tube reactor having cooling and mixing elements into the at least one loop reactor, where the tube reactor can be, for example, a tube reactor of the type CSE-XR from Fluitec Georg AG or an SMR reactor from Sulzer.

In the context of the present invention, a reaction zone is understood to mean a section of a reactor in flow direction of the liquid streams in which the polymerization proceeds. A reaction zone may be disposed within part of a reactor, within a whole reactor or within two or more reactors. In a preferred embodiment, each reaction zone is disposed in a separate reactor.

The internal cooling elements not only enable a very large area for heat exchange between cooling medium and reaction mixture to be generated and a high heat transfer power thus to be achieved, but the cooling elements at the same time ensure and improve mixing of the reaction mixture. The simultaneous mixing and heat removal thus makes a high level of heat removal possible at low temperature differences between cooling medium and reaction mixture.

Loop reactors with internal cooling and mixing elements used in the inventive process are also operated in batch or semibatch mode and are suitable for ensuring thermal homogeneity transverse to the flow direction. At the same time, each differential volume element in principle has essentially the same temperature over the particular flow cross section.

Conventional loop reactors and loop reactors with internal cooling and mixing elements differ by their characteristic dimension and especially by the characteristic dimension of their reaction zones. In the context of the present invention, the “characteristic dimension” of a device, for example of a reactor, is understood to mean the smallest dimension at right angles to the flow direction. The characteristic dimension of the reaction zone of a loop reactor with internal cooling and mixing elements is significantly less than that of a conventional loop reactor (for example at least by a factor of 10 or at least by a factor of 100 or even at least by a factor of 1000) and is typically in the range from several hundreds of nanometers to a few tens of millimeters. It is frequently in the range from 1 μm to 30 mm. Compared to conventional loop reactors, loop reactors with internal cooling and mixing elements therefore exhibit significantly different behavior in relation to the heat and mass transfer processes which proceed. As a result of the greater ratio of surface area to reactor volume, for example, very good heat supply and removal is enabled, which is why it is also possible to carry out strongly endo- or exothermic reactions virtually isothermally.

Conventional loop reactors have a characteristic dimension of >30 mm, loop reactors with internal cooling and mixing elements, in contrast, ≤30 mm.

Usually, the characteristic dimension of the reaction zone of a conventional loop reactor ranges from 30 mm to 700 mm, preferably from 30 mm to 600 mm, more preferably from 30 mm to 500 and particularly preferably from 30 mm to 400 mm.

In general, the characteristic dimension of the reaction zone of a loop reactor with internal cooling and mixing elements is at most 30 mm, for example from 0.1 to 30 mm or preferably from 0.2 to 30 mm or more preferably from 0.4 to 30 mm; preferably at most 20 mm, for example from 0.1 to 20 mm or preferably from 0.2 to 20 mm or more preferably from 0.4 to 20 mm; more preferably at most 15 mm, for example from 0.1 to 15 mm or preferably from 0.2 to 15 mm or more preferably from 0.4 to 15 mm; even more preferably at most 10 mm, for example from 0.1 to 10 mm or preferably from 0.2 to 10 mm or more preferably from 0.4 to 10 mm; even more preferably at most 8 mm, for example from 0.1 to 8 mm or preferably from 0.2 to 8 mm or more preferably from 0.4 to 8 mm; in particular at most 6 mm, for example from 0.1 to 6 mm or preferably from 0.2 to 6 mm or more preferably from 0.4 to 6 mm.

Optionally, the loop reactors with internal cooling and mixing elements may comprise mixing elements permeated by temperature control channels (for example of the CSE-XR type from Fluitec, Switzerland). The optimal characteristic dimension arises from the requirements on the permissible anisothermicity of the reaction, the maximum permissible pressure drop and the proneness of the reactor to become blocked.

Advantageous materials for the mixers and reactors for use in accordance with the invention have been found to be austenitic stainless steels which are corrosion-resistant in the region of low temperatures, such as 1.4541 or 1.4571, generally known as V4A and as V2A respectively, and stainless steels of US types SS316 and SS317Ti. At higher temperatures and under corrosive conditions, PEEK (polyetheretherketone: high-temperature-resistant thermoplastic material) is likewise suitable. However, it is also possible to use more corrosion-resistant Hastelloy types, glass or ceramic as materials and/or corresponding coatings, for example TiN₃, Ni-PTFE, Ni-PFA or the like, for the mixers and reactors for use in accordance with the invention.

Owing to the high coefficients of heat transfer and owing to a high ratio of surface area to reaction volume, the heat transfer is selected such that temperature deviations in the reaction medium relative to the temperature of the temperature control medium of less than 40° C., preferably of less than 20° C., more preferably of less than 10° C. and especially of less than 5° C. occur. The reaction can thus proceed under substantially isothermal and hence defined and controlled conditions. In order to achieve this, according to the exothermicity and characteristic reaction time of the polymerization reaction, a ratio of heat exchange area to reaction volume of greater than 250 m²/m³, preferably greater than 500 m²/m³, more preferably greater than 1000 m²/m³ and especially greater than 2000 m²/m³ is preferably selected.

Preferably, any type of reactor employed within the present invention has at least one feed line for the monomer composition (M), the at least one polyether compound (PE), optionally the at least one free-radical initiator (P) and/or the at least one solvent (S) and at least one outlet for the polymer composition.

In one embodiment, the monomer composition (M) comprises at least one chain transfer agent as monomer component b), the at least one reactor preferably comprises at least two feed lines and monomer component b) is fed into the at least one reactor separately from the at least one olefinically unsaturated acid monomer a).

In one further embodiment, the radical polymerization is carried out in the presence of at least one free-radical initiator (P), the at least one reactor preferably comprises at least two feed lines and the at least one free-radical initiator (P) is fed into the at least one reactor separately from the at least one olefinically unsaturated acid monomer a).

In one preferred embodiment, the monomer composition (M) comprises at least one chain transfer agent b) and the radical polymerization is carried out in the presence of at least one free-radical initiator (P). In this embodiment, the at least one free-radical initiator (P) is fed into the at least one reactor separately from the at least one chain transfer agent b)

In a further preferred embodiment, the at least one reactor preferably comprises at least three feed lines and the at least one free-radical initiator (P), the at least one chain transfer agent b) and the at least one olefinically unsaturated acid monomer a) are preferably fed into the at least one reactor separately from each other.

In one further preferred embodiment, the at least one olefinically unsaturated acid monomer a), the at least one polyether compound (PE), optionally the at least one chain transfer agent b) and optionally the free-radical initiator (P) are fed into the at least one reactor each via different feed lines.

The above-described compounds are usually fed into the reactor in liquid form. Monomers liquid under the feeding conditions can be fed into the at least one reactor without addition of a solvent (S); otherwise, the compounds are used as a solution in a suitable solvent (S).

In a particularly preferred embodiment, in a first step, the at least one polyether compound (PE) is placed in the reactor and afterwards, in a second step, the at least one olefinically unsaturated acid monomer according to monomer component a) and optionally the at least one chain transfer agent according to monomer component b), the at least one further monomer, the at least one solvent (S) and/or the at least one free-radical initiator (P) are fed into the reactor, optionally being mixed within a mixer prior to entering the reactor.

Suitable mixers are known from the prior art. They may in principle be mixers with or without microstructures. Suitable mixers without microstructures, which are also referred to as “conventional” mixers in the context of the present invention, are all mixers which are suitable for the continuous mixing of liquids and are sufficiently well-known to those skilled in the art. They are selected according to the process technology requirements.

Conventional mixers differ from mixers with microstructures by their characteristic 30 dimension in the zone relevant for the mixing. In the context of the present invention, the characteristic dimension of a flow device, for example of a mixer, is understood to mean the smallest dimension at right angles to the flow direction. The characteristic dimension of a micromixer is significantly smaller than that of a conventional mixer (for example lower at least by the factor of 10 or at least by the factor of 100 or at least by the factor of 1000) and is typically in the micrometer to millimeter range.

Conventional mixers have a characteristic dimension in the region relevant for the mixing of more than 10 mm, mixers with microstructures, in contrast, of at most 10 mm. The characteristic dimension of a mixer with microstructures used in accordance with the invention is preferably in the range from 1 μm to 10 000 μm, more preferably in the range from 10 μm to 5000 μm and especially in the range from 25 μm to 4000 μm. The optimal characteristic dimension arises here from the requirements on the mixing quality and the tendency of the mixing apparatus to become blocked.

Mixers with microstructures are also referred to as micromixers. Examples of suitable mixers without microstructures are both conventional dynamic mixers, for example mixing pumps and stirred tanks with continuous flow, and mixing apparatus installed into pipelines, for example baffle plates, orifice plates, jet mixers, T and Y pieces, and static mixers.

Examples of suitable micromixers are:

I. static mixers
1. laminar diffusion mixers
   a) “chaotic-laminar” mixers, for example T mixers, Y mixers or cyclone mixers,
   b) multilamination mixers or interdigital mixers,
2. laminar diffusion mixers with convective crossmixing, for example shaped mixing channels or channels with secondary structures,
3. split-recombine mixers, for example caterpillar mixers;

II. dynamic mixers, for example mixing pumps;

III. combinations thereof;

these of course satisfying the abovementioned conditions for the characteristic dimensions.

Further suitable micromixers that can be used in the inventive process are described in more detail in WO 2009/133186 A1.

Depending on the viscosity of the at least one polyether compound (PE) used, it may be advantageous to heat the at least one polyether compound (PE) before feeding it to the at least one reactor. Preferably, the at least one polyether compound (PE) is heated to a temperature of 20 to 90° C., preferably to a temperature of 30 to 85° C. and especially to a temperature of 40 to 80° C., wherein the heating of the polyether compound (PE) is carried out
i) inside of the reactor or
ii) outside of the reactor and is subsequently fed into the reactor via at least one feed line, wherein the at least one feed line is surrounded by a heat exchanger.

In a preferred embodiment of the present invention, the reactor is a loop reactor and at least one of the loops comprises at least one mixing element and optionally at least one mixing pump, preferably, the content of the reactor comprising the polymer composition and/or the monomer compisition (M) is at least partially transported, preferably pumped, through at least one of the loops comprising at least one mixing element and optionally at least one mixing pump.

Within this embodiment, it is even more preferred that
i) each loop comprises at least one mixing element and at least one mixing pump, and/or
ii) the at least one mixing element is a static mixer or a dynamic mixer, preferably a static mixer, and/or
iii) at least one loop comprises a plurality of mixing elements and at least one mixing pump, preferably each loop comprises a plurality of mixing elements and at least one mixing pump, and/or
iv) the at least one mixing element contains a feed line.

Within this embodiment, it is even more preferred that at least one of the mixing elements contains a feed line and the at least one polyether compound (PE), the at least one olefinic unsaturated acid monomer according to monomer component a), optionally the at least one chain transfer agent according to monomer component b), optionally the at least one free-radical initiator (P), optionally the at least one solvent (S) and/or optionally the at least one further monomer are transported through said feed line.

The invention is illustrated hereinafter by the examples.

### EXAMPLES

In order to evaluate the heat transfer and mass transfer capabilities of a reactor in batch or semibatch mode having a specific volume-based heat removal power (A), theoretical scale-up considerations were carried out in comparison with conventional stirred tank reactors.

Reaction Mixture 1:

| | | |
|---|---|---|
| water | 32% by weight | (solvent) |
| PEO | 21% by weight | (polyether) |
| acrylic acid | 43% by weight | (monomer) |
| mercaptoethanol | 1.0% by weight | (chain transfer agent) |
| sodium hypophosphite | 2.5% by weight | (chain transfer agent) |
| 2,2′-Azobis-2-(amidinopropane) | 0.5% by weight | (initiator) |
| dihydrochloride | | |

The polyether compound PEO is an end-terminated CₓH₂ₓ₊₁/C_{y}H_{2y+1}-polyethyleneoxide having a free OH group with x,y=6 to 14.

Heat Transfer Evaluation

The heat transfer properties for different batch sizes and jacket temperatures of Reaction Mixture 1 in stirred-tank reactors and semi-batch operation compared to a loop reactor with internal cooling and mixing elements in semibatch mode are calculated and are shown in Table 1.

The required heat removal power to remove heat of reaction (B) is calculated following

B=dQ/dt×1/(HTA×ΔT)

with the heat generation rate dQ/dt, the heat transfer area HTA and the difference between reaction and jacket temperature ΔT. The result is compared with the volume-based heat removal power (A) calculated from the Nu-correlation as follows:

A=Nu×Δ/D

with the product heat conductivity λ and the reactor diameter D. The ratio of B/A is compared for different reactor sizes and cooling temperatures.

For the calculation of the heat generation rate, it is assumed that the monomer conversion rate is identical to the feed rate and that heat generation is purely attributed to the heat of polymerization. Heat is only removed by jacket cooling. Specific heat capacity and heat conductivity of the product are roughly estimated from the components.

The Nu number is calculated according to

Nu=c_{Nu}×Re^{m}×Prⁿ×(Pr/Prⱼ)^{p}

with Reynolds number Re, Prandtl number Pr, Prandtl number at the jacket Prⱼ and the following estimated values for spiral and anchor agitator: c_{Nu}=0.5, m=0.6, n=0.33, p=0.14 and stirrer diameter d/D=0.9. The H/D ratio of the reactor was set to 1.25 with H=filling level of the reactor.

The data for the loop reactor with internal cooling and mixing elements (herein further referred to as milli-loop reactor) according to Examples E1 and E2 were calculated for a loop reactor with internal cooling and mixing elements with a batch size of 10 or 40 m³ of polymer composition. Likewise, the batch size relates to the reactor hold-up in the loop. The volume-based heat removal power (A) of 5 kW/(m³·K) is a typical specification for Sulzer SMR static mixer heat exchangers. In contrast to the milli-loop reactor of Examples E1 and E2, the stirred tank reactors of comparative examples CE1 to CE7 have a much lower volume-based heat removal power (A). The respective data are shown in Table 1.

TABLE 1
Results of heat transfer evaluation for different stirred tank reactor (STR)
batch sizes (comparative examples) and jacket temperatures in relation to (batch) loop
reactor (working examples):

| | Stirred Tank Reactor | | | | | | | Loop reactor^{a} | |
|---|---|---|---|---|---|---|---|---|---|
| | Lab | Pilot | | Production | | Production | | Production | |
| | scale | scale | | scale | | scale | | scale | |
| Example | CE1 | CE2 | CE3 | CE4 | CE5 | CE6 | CE7 | E1 | E2 |
| Batch size [m³] | 0.01 | 1.0 | | 10 | | 40 | | 10 | 40 |
| Feed time [min] | 240 | 240 | | 240 | | 240 | | 150 | 150 |
| Reactor | 0.22 | 1.0 | | 2.2 | | 3.4 | | — | — |
| diameter [m] | | | | | | | | | |
| Heat gener. | 0.38 | 38 | | 380 | | 1500 | | 610 | 2400 |
| rate [kW] | | | | | | | | | |
| Heat transfer | 0.19 | 4.0 | | 19 | | 47 | | — | — |
| area [m²] | | | | | | | | | |
| Jacket | 50 | 50 | 25 | 50 | 25 | 50 | 25 | 50 | 50 |
| temperature | | | | | | | | | |
| [° C.] | | | | | | | | | |
| B [W/m³K] | 1520 | 1520 | 760 | 1520 | 760 | 1520 | 760 | 2400 | 2400 |
| Stirring rate | 100 | 40 | 40 | 30 | 30 | 20 | 20 | — | — |
| [1/min] | | | | | | | | | |
| Nu [—] | 71 | 260 | 220 | 550 | 470 | 750 | 640 | — | — |
| A [W/m³K] | 2150 | 364 | 312 | 171 | 146 | 90 | 78 | 5000^{b} | 5000^{b} |
| B/A ratio | 0.71 | 4.2 | 2.4 | 9.0 | 5.3 | 17 | 9.8 | 0.48 | 0.48 |

^{a}using Sulzer SMR static mixer heat exchanger,
^{b}typical lower specification limit for Sulzer SMR static mixer heat exchangers in the specified volume range.

The results show that the preparation of polymer compositions from Reaction Mixture 1 has significant scale-up risks from a heat transfer perspective. For the safe operation of a reactor, the volume-based heat removal power (A) should be at least twice as high as the required heat removal power to remove heat of reaction (B). The difference in the respective B/A ratio during the preparation of the polymer composition from Reaction Mixture 1 in stirred tank reactors having at least pilot scale (see comparative examples CE2 to CE7) is drastic and ranges from 2.4 to 17, which means that the heat will not be removed at an early stage and the reactor requires longer cycle times to remove the heat of polymerization.

By contrast, the respective B/A ratio is only 0.48 for a milli-loop reactor (see examples E1 and E2), even if the feed time of the monomer is decreased to 150 min. In this regard, the milli-loop reactor shows an even smaller B/A ratio compared to very low-scale stirred tank reactions (10 L) of 0.71, as shown in comparative example CE1.

Mass Transfer Evaluation

The maximum theoretical extent of a given mass transfer is typically determined by the point at which the reaction mixture exhibits a uniform concentration of all compounds. In order to verify mass transfer limitations, the characteristic reaction time, i.e. the monomer half-life for a first-order reaction, is calculated following

t_{reac} =In2×[Mon]/r

with the monomer conversion rate r (equal to feed rate according to a steady state approximation) and the monomer concentration [Mon]. The characteristic mixing time is calculated from the homogenization value c_{H} as a function of the chosen stirrer geometry and the Reynolds number. For spiral agitators, the homogenization value stays constant (c_{H}=80) over the whole relevant Reynolds number range (Re<500). The characteristic mixing time is calculated from c_{H} by division through the stirring rate.

The data shown in Table 2 were calculated for a reaction mixture comprising acrylic acid as the at least one olefinically unsaturated acid monomer a). The steady state monomer concentration for acrylic acid in semi-batch operation is commonly around 0.1 to 2.0 mol/L; the present calculations were performed with 0.15 mol/L. The mixing time tₘᵢₓ of 0.03 min is the time the reaction mixture needs to pass 14 mixing elements 30 of a Fluitec DN36 CSE-X static mixer in the recirculation loop at a loop flow velocity of 17.5 m/min.

TABLE 2
Results of mass transfer evaluation for different STR batch sizes and
comparison to (batch) loop reactor:

| | | | | | Loop | Loop |
|---|---|---|---|---|---|---|
| | Stirred Tank Reactor (comparative) | | | | reactor^{a} | reactor^{a} |
| | CE8 | CE9 | CE10 | CE11 | E3 | E4 |
| Batch size [m³] | 0.01 | 1.0 | 10 | 40 | 10 | 40 |
| Feed time | 240 | 240 | 240 | 240 | 150 | 150 |
| [min] | | | | | | |
| Reactor | 0.22 | 1.0 | 2.2 | 3.4 | — | — |
| diameter | | | | | | |
| [m] | | | | | | |
| Reaction rate | 4.8 × 10⁻⁴ | 4.8 × 10⁻⁴ | 4.8 × 10⁻⁴ | 4.8 × 10⁻⁴ | 7.7 × 10⁻⁴ | 7.7 × 10⁻⁴ |
| [mol/(Ls)] | | | | | | |
| Monomer | 0.15 | 0.15 | 0.15 | 0.15 | 0.15 | 0.15 |
| concentration | | | | | | |
| [mol/L] | | | | | | |
| t_{reac} [min] | 3.6 | 3.6 | 3.6 | 3.6 | 2.25 | 2.25 |
| Stirring rate | 100 | 40 | 30 | 20 | — | — |
| [1/min] | | | | | | |
| C_{H} | 80 | 80 | 80 | 80 | — | — |
| tₘᵢₓ [min] | 0.8 | 2.0 | 2.7 | 4.0 | 0.03^{b} | 0.03^{b} |
| t_{reac}/tₘᵢₓ | 4.5 | 1.8 | 1.3 | 0.9 | 75 | 75 |

^{a}using Fluitec DN36 CSE-X static mixers in the recirculation loop,
^{b}time to pass 14 mixing elements for a loop flow velocity of 17.5 m/min.

Due to the high polymerization rate of acrylic acid, this criterion is difficult to meet, however, the above results show that a (batch) milli-loop reactor shows superior properties in this regard with a ratio of t_{reac}/tₘᵢₓ of 75 (see Examples E3 and E4).

1. A process for the preparation of a polymer composition comprising at least one polymer and at least one polyether compound (PE), wherein the polymer is obtained by radical polymerization of a monomer composition (M) which comprises the following monomer components a) and b):
a) at least one olefinically unsaturated acid monomer (monomer component a),
b) optionally at least one chain transfer agent (monomer component b), and
wherein the radical polymerization is carried out in the presence of at least one polyether compound (PE) within at least one reactor,
wherein
i) the at least one reactor is operated in batch or semibatch mode,
ii) the at least one reactor comprises a volume-based heat removal power (A) of at least 3 kW/(m³.1( ) and
iii) the at least one reactor has a volume of at least 10L.

2. The process according to claim 1, wherein
i) the radical polymerization is carried out in the presence of at least one free-radical initiator (P) and/or at least one solvent (S), and/or
ii) the monomer composition (M) optionally comprises at least one further monomer other than monomer components a) and b).

3. The process according to claim 1, wherein the at least one olefinically unsaturated acid monomer according to monomer component a) is selected from the group consisting of α,β-ethylenically unsaturated carboxylic acid monomers, α,β-ethylenically unsaturated sulfonic acid monomers and α,β-ethylenically unsaturated phosphonic acid monomers.

4. The process according to claim 1, wherein the at least one chain transfer agent according to monomer component b) is selected from the group consisting of aldehydes, formic acid, mono- and polyfunctional alcohols, hydroxycarboxylic acids, allyl compounds, mercaptans, hypophosphorus acid and salts of hypophosphorus acid.

5. The process according to claim 2, wherein the at least one free-radical initiator (P) is selected from the group consisting of acetyl hydroperoxide, diacetyl peroxide, benzoyl hydroperoxide, dibenzoyl peroxide, lauroyl peroxide, dilauroyl peroxide, succinyl peroxide, tert-butyl peroxyisobutyrate, tert-butyl hydroperoxide, di-tert-butyl peroxide, tert-butyl peroxyneodecanoate, tert-amyl hydroperoxide, di-tert-amyl peroxide, tert-butyl peroxyacetate, tert-butyl peroxymaleate, diisopropyl peroxydicarbamate, tert-amyl peroxypivalate, tert-butyl peroxypivalate, diisopropyl peroxydicarbonate, 2,2′-azobis(isobutyronitrile), 2,2′-azobis(2-methylbutyronitrile), 2,2′-azobis(2,4-dimethylvaleronitrile), 2,2′-azobis(2-amidinopropane) dihydrochloride, hydrogen peroxide, peroxodisulfuric acid, ammonium peroxodisulfate [[or]] and sodium peroxodisulfate.

6. The process according to claim 1, wherein the at least one polyether compound (PE) comprises at least one surfactant containing polyether groups which is selected from the group consisting of alkyl polyoxyalkylene ethers, aryl polyoxyalkylene ethers, alkylaryl polyoxyalkylene ethers, alkoxylated animal fats, alkoxylated animal oils, alkoxylated vegetable fats, alkoxylated vegetable oils, fatty amine alkoxylates, fatty acid amide alkoxylates, fatty acid diethanolamide alkoxylates, polyoxyethylene sorbitan fatty acid esters, alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride ether sulfates, fatty acid amide ether sulfates and polyoxyalkylene sorbitan fatty acid esters.

7. The process according to claim 2, wherein the radical polymerization is carried out in the presence of the at least one solvent (S) and a reaction mixture comprises the at least one olefinically unsaturated acid monomer a), optionally the at least one chain transfer agent b), the at least one polyether compound (PE), optionally the at least one free-radical initiator (P), the at least one solvent (S), optionally the at least one further monomer and said reaction mixture comprises less than 50% by weight, based on a total weight of said reaction mixture, of the at least one solvent (S).

8. The process according to claim 2, wherein
i) the at least one reactor is operated in semibatch mode and/or
ii) the reactor comprises at least one feed line for the monomer composition (M), the at least one polyether compound (PE), optionally the at least one free-radical initiator (P) and/or the at least one solvent (S) and at least one outlet for the polymer composition, and/or
iii) a batch comprising the polymer composition and/or the monomer composition (M) has a size of at least 100 L inside of the at least one reactor during operation in batch or semibatch mode, and/or
iv) the at least one reactor has a volume-based heat removal power (A) of at least 5 kW/(m³·K), and/or
v) the at least one reactor has a volume of at least 100 L.

9. The process according to claim 8, wherein the at least one reactor comprises at least two feed lines and
i) the at least one free-radical initiator (P) is fed into the at least one reactor separately from the at least one olefinically unsaturated acid monomer according to monomer component a), and/or
ii) the at least one free-radical initiator (P) is fed into the reactor separately from the at least one chain transfer agent according to monomer component b).

10. The process according to claim 2, wherein, in a first step, the at least one polyether compound (PE) is placed in the at least one reactor and afterwards, in a second step, the at least one olefinically unsaturated acid monomer according to monomer component a) and optionally the at least one chain transfer agent according to monomer component b), the at least one further monomer, the at least one solvent (S) and/or the at least one free-radical initiator (P) are fed into the at least one reactor, optionally being mixed within a mixer prior to entering the at least one reactor.

11. The process according to claim 1, wherein the at least one polyether compound (PE) is heated to a temperature of 20 to 90° C.,
wherein the heating of the polyether compound (PE) is carried out
i) inside of the at least one reactor or
ii) outside of the at least one reactor and is subsequently fed into the at least one reactor via at least one feed line, wherein the at least one feed line is surrounded by a heat exchanger.

12. The process according to claim 1, wherein the at least one reactor is a loop reactor and
a smallest dimension at right angles to a flow direction ranges from 30 mm to 700 mm, or
the smallest dimension at right angles to the flow direction ranges from 0.1 to 30 mm, or
the smallest dimension at right angles to the flow direction ranges from 0.1 to 6 mm.

13. The process according to claim 1, wherein the at least one reactor is a loop reactor and at least one of the loops comprises at least one mixing element and optionally at least one mixing pump.

14. The process according to any claim 13, wherein
i) each loop comprises at least one mixing element and at least one mixing pump, and/or
ii) the at least one mixing element is a static mixer or a dynamic mixer, and/or
iii) at least one loop comprises a plurality of mixing elements and at least one mixing pump, and/or
iv) the at least one mixing element contains a feed line.

15. The process according to claim 13, wherein at least one of the mixing elements contains a feed line and the at least one polyether compound (PE), the at least one olefinic unsaturated acid monomer according to monomer component a), optionally the at least one chain transfer agent according to monomer component b), optionally the at least one free-radical initiator (P), optionally the at least one solvent (S) and/or optionally the at least one further monomer are transported through said feed line.

16. The process according to claim 2, wherein the at least one further monomer is at least one monomer selected from the group consisting of polyether acrylates, allyl alcohol alkoxylates, vinylaromatics, esters of α,β-ethylenically unsaturated mono- and dicarboxylic acids with C₁-C₂₀-alcanols, compounds having one free-radically polymerizable α,β-ethylenically unsaturated double bond and at least one cationogenic group per molecule, compounds having one free-radically polymerizable α,β-ethylenically unsaturated double bond and at least one cationic group per molecule, compounds having one free-radically polymerizable α,β-ethylenically unsaturated double bond and at least one cationogenic and at least one cationic group per molecule, esters of vinyl alcohol or allyl alcohol with C₁-C₃₀-monocarboxylic acids, olefinically unsaturated monomers containing amide groups, esters of α,β-ethylenically unsaturated mono- and dicarboxylic acids with C₂-C₃₀-alkanediols, amides of α,β-ethylenically unsaturated mono- and dicarboxylic acids with C₂-C₃₀-amino alcohols having a primary or secondary amino group, α,β-ethylenically unsaturated nitriles and olefinically unsaturated monomers having urea groups.

17. The process according to claim 1, wherein the monomer component a) is selected from the group consisting of acrylic acid, methacrylic acid, ethacrylic acid, α-chloroacrylic acid, crotonic acid, maleic acid, itaconic acid, citraconic acid, mesaconic acid, glutaconic acid, aconitic acid, fumaric acid, 2-acrylamido-2-methylpropanesulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, vinylphosphonic acid and allylphosphonic acid.

18. The process according to claim 4, wherein the monomer component b) is selected from the group consisting of formic acid, mercaptans, and sodium hypophosphite.

19. The process according to claim 7, wherein said reaction mixture comprises less than 30% by weight, based on the total weight of said reaction mixture, of the at least one solvent (S).

20. The process according to claim 19, wherein said reaction mixture comprises less than 10% by weight, based on the total weight of said reaction mixture, of the at least one solvent (S).
